(19) United States
(12) Patent Application Publication
(10) Pub. No.: US 2012/0034365 A1
(43) Pub. Date: Feb. 9, 2012

(54) Method for producing an instant ground meat product and instant ground meat produced according to the method

(75) Inventors: Peter Eisner, Freising (DE); Erwin Denker, Hechendorf-Murnau (DE); Klaus Mueller, Freising (DE); Christian Zacherl, Freising (DE)

(73) Assignee: FRAUNHOFER GESELLSCHAFT ZUR FOEDERUNG DER ANGEWANDTEN FORSCHUN

(21) Appl. No.: 13/200,842

(22) Filed: Oct. 3, 2011

Related U.S. Application Data
(63) Continuation of application No. PCT/DE2009/000433, filed on Apr. 3, 2009.

(51) Int. Cl. C11B 5/00; A23L 1/317; A23B 4/06; A23L 1/22

(52) U.S. Cl. 426/542; 426/615; 426/641; 426/385

(57) ABSTRACT

A method for producing an instant ground meat product from at least one ground meat molded blank which is placed on a rack or a bottom of a drying chamber of a freeze-drier in order to be freeze-dried. A projection surface of the ground meat molded blank has a maximum size, such as maximum diameter or edge length, of 2 to 16 cm on the rack or tray of a freeze-drier and a maximum height of 1 to 4 cm in relation to the rack.

### RELATED APPLICATIONS

This application is a continuation of International application PCT/DE2009/000433 filed on Apr. 3, 2009 which is incorporated in its entirety by this reference.

### FIELD OF THE INVENTION

The invention relates to a method for producing an instant ground meat product that includes arranging a ground meat molded blank on a rack or on a tray of a drying chamber of a freeze dryer for freeze drying where a projection surface of the ground meat molded blank on the rack or on the tray of the freeze dryer has a maximum diameter or edge length of 2 to 16 cm and a greatest height of 1 to 4 cm with reference to the rack or the tray and to an instant ground meat product produced according to the method.

### BACKGROUND OF THE INVENTION

Freeze-drying extracts water from the fresh meat and thus generates a dry instant meat product which can be returned into a consistency which is very similar to the consistency of fresh meat after water is added again (rehydration). A dry product of this type that is based on ground meat which is only ready to use after a rehydration is subsequently designated as instant ground meat product.

Freeze-dryers include a drying chamber, heatable or cool able trays or racks within the drying chamber, a refrigeration machine, a condenser, an intermediary valve, a vacuum pump and ventilation valves. The process of freeze-drying then runs as follows:

During freezing, the water included in the object to be freeze-dried is completely frozen into ice. Opening the intermediary valve activates the condenser and the vacuum pump for the main drying process. During the main drying process, the ice generated during freezing is removed from the object. The vacuum pump generates a vacuum in the drying chamber through which the water sublimates; this means the water transitions from a solid state (ice) into a gaseous state. Through the sublimation, the water exits from the object. The heat energy required for this reaction is generated by heatable trays or racks in the drying chamber. The exiting water vapor then migrates into the condenser cavity cooled by the refrigeration machine. Through the cold, the water vapor transforms into ice and precipitates at the walls of the condenser cavity. In order to check whether the process of freeze-drying is totally completed the intermediary valve is closed. In case the vacuum is maintained during closing the intermediary valve, the drying is completed. However, when there is residual humidity, the main drying process has to be started again. During the main drying process, a large percentage of the water has been removed from the object which then, however, can still include bonded water. The bonded water is then also converted into gas and removed in the context of a post-drying process.

A method according to the invention for freeze-drying ground meat is described in GB 989 545 A, wherein larger amounts of ground meat, approximately 14 kg of ground meat are evenly distributed on trays of the drying chamber. Thus a relatively large coherent amount of ground meat is freeze dried which causes a small freeze drying speed. In order to obtain a freeze drying speed that is acceptable for industrial applications the energy used for the freeze drying process would have to be substantially increased which is not economical.

In some cases also dry products are produced through freeze drying, wherein the dry products only bond small amounts of water after renewed water application and therefore have a rather low degree of rehydration. Consequently products of this type are described as dry and brittle during sensory tasting. Since dry products generated in this manner typically also have a rancid smell they are not very enjoyable.

The textural properties negatively affected in some dry products are caused by the reduced naturalness due to the drying and the inherently worse water bonding of the meat proteins has the consequence that the original water content of fresh ground meat cannot be reached after water is added again to the dry product (rehydration).

### BRIEF SUMMARY OF THE INVENTION

Thus it is the object of the present invention to provide a method for producing an instant ground meat product which implements a freeze drying process in a more economical manner, in particular with comparatively high freeze drying velocity. At the same time the ground meat dried through the method shall have a very high degree of rehydration, a high rehydration speed and excellent sensory properties.

### BRIEF DESCRIPTION OF THE DRAWINGS

The invention will be described in detail with reference to the following drawings in which like reference numerals refer to like elements wherein:

FIG. 1 illustrates a generally rectangular ground meat molded blank;

FIG. 2 illustrates a generally spherical ground meat molded blank; and

FIG. 3 illustrates a generally irregular shaped ground meat molded blank.

### DETAILED DESCRIPTION OF THE INVENTION

The invention is based on the idea that a projection surface of the ground meat molded blank on a rack or a tray of a freeze drier has a largest dimension like a diameter or an edge length of 2 to 16 cm and with reference to the rack or tray a greatest height of 1 to 4 cm.

The projection surface defines the outline of the ground meat molded blank, wherein the outline is created when an imaginary pen is that is run about the ground meat molded blank orthogonal to the rack receiving the meat molded blank and the circumference line created is drawn onto the rack.

For example, more or less regular cuboid, square or cylindrical molded blanks can be produced as starting products for the freeze-drying process, but also molded blanks with irregular shapes, for example, in the shape of a pile. However also strand or sausage shaped molded blanks are conceivable.

In cuboids or cubes, the projection surface is a rectangle or a square, wherein the greatest edge length of the rectangle is its length.

In essentially cylindrical ground meat blanks as they are used, for example, for hamburger patties or meatloaves, the diameter of the circular projection surface has to be used. Also, cylindrical elongated and sausage-like molded blanks are conceivable which contact the rack or the tray with their enveloping surfaces, like, for example, ground meat sausages for Cevapcici. In this case, the largest dimension of the projection surface is formed by the length of the cylindrical ground meat roll in axial direction.

Last not least also spherical ground meat molded blanks can be used, for example, configured as meatballs as they are being served together with spaghetti. Such spherical structures are flattened at their base side and differ from a spherical shape due to their soft consistency. The diameter of the sphere then becomes the largest dimension of the projection surface.

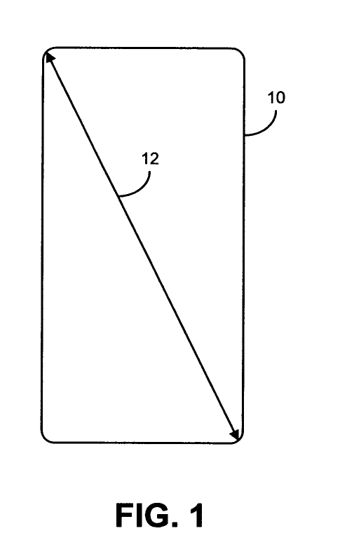

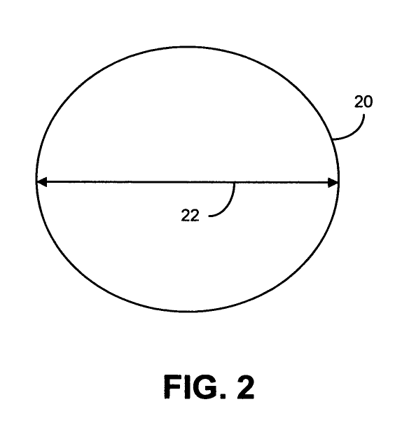

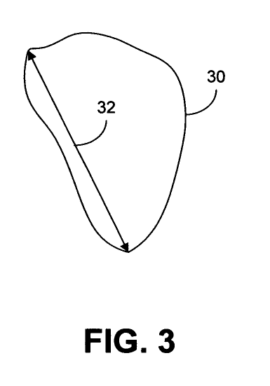

For example, FIG. 1 illustrates a generally rectangular ground meat molded blank 10 such as a fish stick having a diagonal 12 as its largest dimension. Another example is FIG. 2 which illustrates a generally spherical ground meat molded blank 20 having a diameter 22 as its largest dimension. Yet another example is FIG. 3 which illustrates a generally irregular shaped ground meat molded blank 30 having an edge 22 as its largest dimension.

Overall it is advantageous that such typically industrially produced ground meat molded blanks can be brought into the subsequently consumable shape already before freeze drying and therefore in a soft state where they can be easily molded and shaped and are subsequently freeze dried in this shape. The ground meat mass then does not have to be brought into shape in freeze dried and hard condition as this is the case in GB 989 545 A recited supra where a relatively large mass of ground meat is spread plate shaped on the shelves or trays and the final shape still has to be produced after freeze drying, for example, through sawing.

In a pile that is uneven compared to the above the largest dimension with respect to the projection surface of the pile on the rack shall also be in a range of 2 to 16 cm. Since also the height distribution is uneven in a pile like that the greatest height of the pile shall be in a range between 1 to 4 cm

Thus it is important that sufficient space is provided between the particular molded blanks arranged separately from one another on the shelves or on a rack in order for the vacuum or the heat to be able to impact a portion of the surface of the molded blanks that is as large as possible. Since the shelves of freeze dryers are typically configured with as perforated plates and thus are provided with pass through openings the atmosphere in the drying chamber can also reach the ground meat molded blanks from their bottoms.

When ground meat molded blanks have such dimensions during freeze drying, this yields a rather high freeze drying speed which makes the freeze drying process very economical. The freeze-dried ground meat molded blanks can be hydrated quickly and have good sensory properties.

When the dimensions of the ground meat molded blanks in the freeze dryer are smaller and, for example, the greatest edge length or the diameter undercut 2 cm or the height undercuts 1 cm, this yields a smaller rehydration speed after freeze drying compared to ground meat molded blanks sized according to the invention. Furthermore also the degree rehydration, this means the capability to absorb water is lower.

For the greatest edge length or for diameters of more than 16 cm or for a greatest height of more than 4 cm the freeze drying speed is significantly reduced which causes non-economical freeze drying and is therefore not economical as stated supra.

Ground meat molded blanks have a mass in a range of 5 to 1000 g before freeze drying. Even better properties with respect to drying throughput, rehydration speed, degree of rehydration and product quality can be obtained when the projection surface of the ground meat molded blank on the rack of the freeze dryer has a maximum dimension like a diameter or an edge length of 3 to 5 cm, and with respect to the rack a greatest height of 2 to 4 cm. The mass of a ground meat molded blank of this type then is in a range of 20 to 100 g.

With respect to the mass to surface ratio of a ground meat molded blank arranged on the rack before freeze drying, this means the ratio of its mass to its surface a range of 1 kg/m² to 7 kg/m² is favorable

The freeze-dried instant ground meat product obtained through the method described is then characterized by the following properties:
the water content is less than 5% by weight, in particular less than 3% by weight;
the meat protein content is greater than 75% by weight, in particular greater than 85% by weight with reference to the dry mass; and
the meat proteins have such a high naturalness that the dry instant ground meat product can absorb so much water that the water content in the rehydrated ground meat is even higher than in the fresh ground meat.

It has furthermore become apparent that more than 75% water could be bonded in the instant ground meat product according to the invention which was produced from fresh ground meat with a water content of 68% to 73% without the water exiting from the rehydrated ground meat mass. From the rehydrated ground meat molded blanks particularly juicy and sensory pleasant meat products like, for example, meat balls could be obtained. A sensory difference from meat loafs made from fresh ground meat was not perceivable

The instant ground meat product according to the invention or a ground meat that is ready to use or ready to eat is produced according to the method described infra:

In particular pork, beef, poultry, or fish meat by itself or in a mix is suitable as a base material for the ground meat molded blanks. The meat can be mixed before freeze drying with spices, vegetables or other ingredients. The ingredients are subsequently also freeze dried. Optionally the ingredients can also be added as dry ingredients in the packaging after freeze drying the ground meat. The ground meat ingredient mix can then be packaged as an instant product and is provided as a food that is ready to eat after rehydrating and heating.

Low Oxidation Pre-Treatment

In order to achieve a particularly high amount of naturalness (water bonding) of the meat product, fresh meat is freeze-dried in a gentle manner after adding an oxidation retarding agent (antioxidant). A ground meat freeze-dried in this manner furthermore has excellent taste properties. Particular sensory advantages with respect to smell and taste are achieved when the instant meat product includes antioxidant components that are distributed in the most even manner possible, in particular in the form of plant extracts.

For a particularly even distribution of antioxidants or of an antioxidant in the meat or at the meat it is advantageous to add one or plural amphiphile or lipophile substances to the meat before freeze-drying, so that according to an advantageous embodiment, the instant ground meat product also includes portions with these ingredients. A substance is designated as lipophile, which is easily soluble in fats or oils. Amphiphile substances are at least partially soluble in water and also in lipophile substances.

Typically an antioxidant like, for example, rosemary extract is added to meat products in order to reduce oxidation processes. However, for ground meat due to the large product surface and the fine distribution of the oxidation sensitive meat fat, the distribution of the antioxidant is very difficult.

This problem is solved through thinning the antioxidant or the antioxidants in a fat phase that is added with reference to the already existing intrinsic fat content of the fresh ground meat, wherein the fat phase is gradually worked into the meat in increments which are mixed with larger meat pieces or applied to the meat pieces. Thus, it is apparent that this way fine-distributed antioxidants are directly adsorbed at the fat particles or introduced into the fat particles and thus can become effective at the most oxidation sensitive spots of the ground meat. A reduced oxidation propensity is measurable at the instant ground meat products produced in this manner.

It is particularly advantageous that the antioxidants or the antioxidant are distributed in a fat phase with a high percentage of saturated fatty acids. Thus, a long availability of the antioxidant in the meat can be assured. It is also possible to use amphiphile materials like alcohols or other materials like combinations of mono-/diglycerides.

Natural or synthetic substances can be used as antioxidants. Using natural antioxidants like rosemary extract, alpha-tocopherol and gamma-tocopherol is particularly advantageous.

The antioxidant pretreatment is used according to an exemplary embodiment but it is not mandatory.

Pre-Cooking

Subsequently pre-cooking the base material is described which has an advantage for several ingredients that are included in the packaging like freeze-dried ground meat molded blanks and a dried spice mix that both ingredients can then have the same preparation time. Accordingly the pre-cooking time for the ground meat is advantageously selected so that the remaining cooking time that is still required in rehydrated condition corresponds to the cooking time of the ingredients. Thus the simplest and quickest possible preparation time for the rehydrated ground meat because is provided.

The pre-cooking can be performed according to two new variants depending on the desired result.

Pre-cooking can be provided in two variants depending on the desired result.

Variant 1

Ground meat according to the requirements of the final product or characteristically broken down meat is filled according to the anti oxidative treatment recited supra into suitable guts, shells or molds and cooked, broiled, simmered or baked in a vapor phase, hot air, water bath or other suitable media until a desired cooking point is reached, for example, when the core temperature of the ground meat has a temperature of more than 75° C. Heat resistance and heat permeability as properties of the shells, jackets or molds are prerequisites.

Shortly after the pre-cooking process, the ground meat which is still hot is removed from the guts in order to separate the particles agglomerated at one another through the cooking process through a cutter or other suitable devices before cooling down.

Variant 2

As an alternative to variant 1, meat is not only used as ground meat but in entire larger pieces and cooked, broiled or simmered in suitable media until the desired pre-cooking point is achieved. After the pre-cooking process the meat can be cut either in still heated condition or in already cooled condition through a meat grinder, a cutter or other suitable devices to a desired characteristic size or granulation to form ground meat.

The optional application or introduction of antioxidants (c.f. oxidation retarding pretreatment) onto the meat or into the meat in this case is performed before cooking and/or after cutting the meat into ground meat in order to protect the surfaces newly formed after oxidation against oxidation.

Another advantage of pre-cooking is energy savings through the water already being removed from the ground meat during pre-cooking. The water already removed from the ground meat before freeze-drying (depending on the method between 15 and 25% by weight) does not have to be lyophilized or removed by comparatively expensive freeze-drying. Thus, original and not pre-cooked ground meat masses or characteristically broken down meat masses have a water content of 73% by weight up to 74% by weight, pre-cooked ground meat masses or characteristically broken down meat masses depending on the pre-cooking method, however, only have a water content of 55% to 65% by weight.

Another advantage of the two methods described supra is the far-going denaturization and remaining of the meat inherent proteins within the meat matrix which has positive influences upon the sensory properties and the quality of the final product.

As an additional alternative, ground meat or characteristically cut meat can be pre-cooked to the desirable cooking point, for example, through simmering or roasting. A subsequent cutting, however, is no longer required. During roasting, large amounts of proteins that are indigenous to the meat are released from the meat matrix and their denaturalization then occurs outside of the meat matrix. This leads to a grey coloring of the denaturalized proteins and thus to a formation of murky substances, which remain visible in the end product like, for example, sauces.

Forming of Ground Meat Molded Blanks

After pre-cooking ground meat is formed into ground meat molded blanks advantageously in not yet frozen condition.

Thus, a projection surface of a ground meat molded blank on a rack or a base of the drying chamber of the freeze-dryer shall have a maximum dimension like a diameter or an edge length of 2 to 16 cm and with respect to the rack or the tray, a maximum height of 1 to 4 cm.

The ground meat mass therefore does not have to be shaped in freeze-dried and hard condition as it is the case, for example, GB 989 545 A where a rather large ground meat volume is spread out plate shaped on the shelves or trays and the final shape only has to be generated through cutting after freeze drying, for example, through saw cutting. Thus in an irregular pile the largest dimension of the projection surface of the pile on the rack shall also be in a range between 2 to 16 cm. Since the height extension of such a pile is irregular the greatest height of the pile should be in a range between 1 to 4 cm.

Ground meat molded blanks have a mass in a range of 5 to 1000 g before freeze drying.

Even better properties with respect to drying through put, rehydration speed, degree of rehydration and produce quality can be obtained when the projection surface of the ground meat molded blank on the rack of the freeze dryer has a maximum dimension like a diameter or a edge length of 3 to 5 cm and with respect to the rack a greatest height of 2 to 4 cm. The mass of a ground meat molded blank of this type then is in a range of 20 to 100 g.

With respect to the mass to surface ratio of a ground meat molded blank arranged on the rack before freeze drying, this means the ratio of its mass to its surface a range of 1 kg/m² to 7 kg/m² is preferred.

Thereafter the ground meat or the characteristically cut meat or the ground meat molded blanks are cooled or frozen as quickly as possible. Thus a cooling the 0° C. to −1° C. is desirable. This process will be described infra in more detail.

Freeze Drying

Freeze drying is a particularly gentle type of drying in order to remove water from the ground meat molded blanks as quickly as possible. Freeze drying or lyophilisation or sublimation drying is a drying of objects which are typically already in frozen condition. This means that the ground meat including water is freeze-dried and subsequently placed into the drying chamber of a freeze dryer. Therein it is exposed to a vacuum of less than 6 mbar. Under the influence of the vacuum the frozen water during the entire drying process does not go into liquid state any more but it directly transitions from ice into vapor (sublimation).

It has proven advantageous in particular when the preferably pre-cooked ground meat molded blanks are not put into the drying chamber of the freeze dryer in frozen condition, but in partially or non-frozen condition in order to extract sufficient energy and humidity from the ground meat molded blanks through a quick generation of a vacuum in the drying chamber so that they are freeze-dried during the drying process.

Thus on the one hand side the proteins in the ground meat are saved and the water bonding capacity of the dry product is maintained in a better manner than when a prior freeze drying is performed. On the other hand side a shorter processing or working time is feasible because the typical freezing phase of the fresh ground meat in freezers can be omitted. The shorter processing time of the ground meat reduces the growth of microorganisms and the occurrence of oxidation processes which can create rancidness. Furthermore color changes of the drying material are reduced and the water bonding is influenced in a positive manner.

Alternatively the pre-cooked ground meat molded blanks can also be inserted into the drying chamber of the freeze dryer in completely frozen condition and the vacuum can then be generated.

Drying and storing at a residual humidity or residual water contents below 5% by weight better below 3% by weight is advantageous with respect to the rehydration capability. Thus it is apparent that the water absorption during constitution occurs quicker due to a higher osmotic pull.

It is also apparent that adding 0.5-1.5% salt (NaCl) before freeze drying has no negative effect upon the drying speed, though a higher water bonding capability is achieved when adding salt.

It is advantageous to package the freeze-dried ground meat molded blanks and possibly additional ingredients under exclusion of light and CO₂ in a vapor, oxygen and light proof packaging under a protective gas atmosphere. It has proven particularly advantageous to perform the packaging in an atmosphere of 70% N₂ and 30% CO₂.

Rehydrating

When rehydrating freeze-dried ground meat molded blanks produced according to the method recited supra the water bonding was high enough so that 1%-3% more water could be bonded than was included in the original fresh ground meat. In spite of the greater water content products could be obtained that were comparable with fresh ground meat with respect to their haptic and sensory properties.

Thus the freeze-dried ground meat molded blanks were poured with a respective amount of cold water and heated. After cooking for approximately 2 minutes at 80° C. to 90° C. they were ready for consumption. Preparation is simplified in particular in combination with a spice mix which facilitates an application in commercial kitchens.

It has become apparent that an advantageous overall effect is achieved through combining the pre-cooking process with freeze drying pre-cooked ground meat molded blanks in the characteristic dimensions described supra since the pre-cooking process reduces the cooking time required after rehydration and the selected sizing of the freeze-dried ground meat molded blanks facilitates a quick hydration so that overall a low preparation time of the instant ground meat product is achieved which in particular improves the acceptance of an instant ground meat product of this type at the consumer.

### Embodiment 1

The following ingredients were used as base materials for producing freeze-dried ground meat molded blanks:

| | |
|---|---|
| Fresh ground pork, cooled but not frozen through | 1 kg |
| category S1 | |
| antioxidant mix: | |
| plant oil (sunflower) | 9.0 g |
| Rosemary extract (carnomaxx) | 0.4 g |

Thus, the antioxidant mix was stirred for approx. Ten minutes at a temperature of 1 to 10° C. into 400 g of the fresh ground meat. Subsequently the rest of the ground meat (600 g) is mixed with the ground meat that is already provided with the antioxidant mix.

In the next step molded blanks with approximately 50 g were formed as irregular lumps from the ground meat mass obtained in this manner with a maximum edge length of 3 to 5 cm and a greatest height of 2 to 4 cm on the racks of a freeze-drier and distributed.

During subsequent freeze drying the pressure in the drying chamber was lowered during freeze drying from ambient pressure within less than 10 minutes to approximately 1 mbar. The maximum heating plate temperature was 40° C., the drying time was approximately 12 to 16 hours, wherein the drying chamber of the freeze dryer was supplied with nitrogen. After drying the drying chamber was ventilated with nitrogen.

Eventually the freeze dried ground meat molded blanks were packaged together with the spices under a protective gas atmosphere.

### Embodiment 2

For producing freeze dried ground meat molded blanks the following ingredients were used as base materials:

| | |
|---|---|
| Fresh ground pork Category S1 | 100 kg |
| Antioxidant mix: | |
| plant oil (sunflower) | 900 g |
| Rosemary extract (Carnomaxx) | 40 g |

The antioxidant mix is dissolved in the fat phase with ten minute stirring at a temperature of 1 to 10° C. Working the antioxidant mix into 4000 g of the ground meat, subsequently mixing the ground meat with the rest of the ground meat.

Subsequently the ground meat provided with antioxidants is pre-cooked in the cooking cutter in a backward process at 90° C. for 20 minutes.

Then the pre-cooked ground meat is applied to racks of the freeze dryer, wherein molded blanks with a greatest edge length of 3 to 5 cm and a greatest height of 2 to 4 cm were formed.

In the context of the subsequent freeze drying the pressure in the drying chamber is reduced from atmospheric pressure within less than 10 minutes to approximately 1 mbar. The maximum heating temperature was 80° C. the drying time was 8 to 12 hours, wherein the drying chamber of the freeze dryer was subsequently was ventilated with nitrogen.

Eventually the freeze dried ground meat molded blanks were packaged together with spices under a protective gas atmosphere.

What is claimed is:

1. A method for producing an instant ground meat product including at least one ground meat molded blank comprising:
providing a ground meat molded blank; and
arranging the ground meat molded blank on a rack or on a tray of a drying chamber of a freeze dryer for freeze drying,
wherein a projection surface of the ground meat molded blank on the rack or on the tray of the freeze dryer has a maximum diameter or edge length of 2 to 16 cm and a greatest height of 1 to 4 cm with reference to the rack or the tray.

2. The method according to claim 1, wherein the ground meat molded blank has a mass in a range of 5 to 1000 g before freeze drying.

3. The method according to claim 1, wherein a projection surface of the ground meat molded blank has a largest dimension of 3 to 5 cm and a height of 2 to 4 cm with respect to the rack.

4. The method according to claim 2, wherein the ground meat molded blank has a mass in a range of 20 to 100 g before freeze drying.

5. The method according to claim 1, wherein ground meat molded blanks have a mass/surface ratio in a range 1 to 7 kg/m² before freeze drying.

6. The method according to claim 1, wherein ground pork or ground beef or ground poultry or ground fish meat are used as base material for the ground meat molded blanks.

7. The method according to claim 6, wherein before forming the ground meat into at least one ground meat molded blank at least one antioxidant is introduced into a separate fat phase or amphiphile or lipophile phase which is an additional fat phase with reference to an intrinsic fat content already included in the ground meat and which is mixed with at least a portion of the ground meat.

8. The method according to claim 7, wherein the amphiphile or lipophile phase includes oil, fat, alcohol and for combinations of mono-/diglycerides.

9. The method according to claim 8, wherein the amphiphile or lipophile phase includes at least a portion of saturated fatty acids.

10. The method according to claim 7, wherein a natural or synthetic antioxidant is used as an antioxidant.

11. The method according to claim 10, wherein rosemary extract or alpha tocopherol or gamma tocopherol or vitamin C or carotene is used as a natural antioxidant.

12. The method according to claim 1, wherein the ground meat is cooked, broiled, simmered or roasted in a pre-cooking process before freeze drying.

13. The method according to claim 12, wherein the ground meat is filled into guts, shells or molds in the pre-cooking process and cooked, broiled, simmered or baked in a vapor phase, hot air or in a water bath.

14. The method according to claim 12, wherein the pre-cooking process of the ground meat is performed so that the core temperature of the ground meat is 75° C. or more.

15. The method according to one of the preceding claims, wherein 0.5 to 1.5% by weight salt is added to the ground meat before forming into the at least one ground meat molded blank and before freeze drying.

16. The method according to claim 1, wherein spices, vegetables or ingredients are added to the ground meat before forming into the at least one ground meat molded blank and before freeze drying.

17. The method according to claim 1, wherein the at least one ground meat molded blank has a water content of 68 to 78% before freeze drying.

18. The method according to claim 1, wherein the at least one ground meat molded blank is arranged on the rack of the freeze drier in non-frozen or in frozen condition.

19. The method according to claim 1, wherein the freeze drying of the at least one ground meat molded blank is performed so that it has a moisture content or a water content of less than 5% by weight.

20. The method according to claim 1, wherein the freeze-dried ground meat molded blank is packaged under exclusion of light and oxygen in a protective gas atmosphere into a vapor, oxygen and light proof packaging.

21. An instant ground meat product produced according to a method according to claim 1.

22. The instant ground meat product according to claim 21, wherein the at least one freeze-dried ground meat molded blank has a water content of less than 5% by weight.

23. The instant ground meat product according to claim 21, wherein the meat protein content of the at least one freeze-dried ground meat molded blank is greater than 75% by weight.

24. The method according to claim 1, wherein the freeze drying of the at least one ground meat molded blank is performed so that it has a moisture content or a water content of less than 3% by weight.

25. The instant ground meat product according to claim 21, wherein the at least one freeze-dried ground meat molded blank has a water content of less than 3% by weight.

26. The instant ground meat product according to claim 21, wherein the meat protein content of the at least one freeze-dried ground meat molded blank is greater than 85% by weight.
